(19) United States
(12) Patent Application Publication
(10) Pub. No.: US 2016/0008671 A1
(43) Pub. Date: Jan. 14, 2016

(54) Ball With Injection Molded Foam Core

(71) Applicant: Rawlings Sporting Goods Company, Inc., St. Louis, MO (US)

(72) Inventors: Sam Bhargava, Columbia, SC (US); Adam Trenkamp, St. Louis, MO (US); Biju Mathew, St. Charles, MO (US)

(73) Assignee: Rawlings Sporting Goods Company, Inc., St. Louis, MO (US)

(21) Appl. No.: 14/605,502

(22) Filed: Jan. 26, 2015

Related U.S. Application Data
(60) Provisional application No. 61/931,545, filed on Jan. 24, 2014.

(51) Int. Cl. A63B 37/06; B29C 45/72; B29C 45/00; B29C 44/04; C08J 9/08; B29C 35/02

(52) U.S. Cl. CPC A63B 37/06; C08J 9/08; B29C 35/0222; B29C 45/0001; B29C 44/04; B29C 45/72; C08J 2369/00; C08J 2455/02; C08J 2425/06; C08J 2355/02; B29L 2031/54

(57) ABSTRACT

The present disclosure relates generally to an injection molded foam core composition, and a method of manufacturing the foam core. The core is made of an injection molded foam from a resin with glass temperature higher than 50° Celsius and provides improved ball performance tolerances as compared to prior art molded balls.

This application is based on and claims priority to U.S. Provisional Application Ser. No. 61/931,545, filed on Jan. 24, 2014, which is incorporated herein by reference in its entirety. This Non-provisional Patent Application is filed by Rawlings Sporting Goods, Inc. for an invention by Sam Bhargava, a citizen of the United States, residing in Clarksville, Md., Adam Trenkamp, a citizen of the United States, residing in St. Louis, Mo., and Biju Mathew, a citizen of India, residing in St. Charles, Mo., for the disclosure of a “Ball With Injection Molded Foam Core”.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

All patents and publications described or discussed herein are hereby incorporated by reference in their entirety.

### FIELD OF DISCLOSURE

The current disclosure relates generally to a ball, and a method of manufacturing a ball, used in diamond sports. More particularly, the current disclosure relates to injection molded foam cores for softballs and baseballs.

### BACKGROUND OF THE DISCLOSURE

In diamond sports, such as baseball and softball, the ball has a fairly consistent structure. The conventional balls in these sports typically have a core, formed of rubber, cork, or thermoset polyurethane foam having a winding wrapped around the core. The winding is typically made of yarn and/or threads made of wool and/or cotton. A cover then is applied over the wound layers Softball covers typically are a vinyl, microfiber, or leather material with a polyurethane coating. Non-leather baseball covers are made of similar materials. Leather baseball covers typically are made of leather alone. This construction of a conventional baseball or softball is typically performed by hand.

Further, the physical characteristics of the ball rely heavily on the materials and the assembly process. For example, the weight of the ball is determined by the density of the materials as well as the tension of the windings around the core. The assembly process also affects other characteristics of the ball, such as the compression, the coefficient of restitution, and the dynamic stiffness. The very nature of the individual hand process used to create the balls creates variances within the balls. In fact, characteristics can vary significantly from balls made by the same individual. Additional sources of variation from the formed spherical foam core or cork core include inconsistencies in ball density and cell size.

Some in the art have made attempts to use alternate materials and/or automate the process of making baseballs or softballs. For example, U.S. Pat. Nos. 3,976,295 (reactive molding—pour mold unrelated-VOC issues, long cycle times); 4,144,297 (reactive molding—pour mold unrelated-VOC issues, long cycle times); and 4,211,407(reactive molding—pour mold unrelated-VOC issues, long cycle times), disclose baseballs and/or softballs made by foam injection molding. Since EVA has a glass transition temperature which depends on the vinyl acetate content, but is definitely lower than 280 Kelvin. The balls performance deteriorates with age as ball is stored and used at temperatures higher than the glass transition where polymer molecules have sufficient mobility to. Further desired compressibility and COR is not achieved as a direct consequence of the material selection process, such as a thermal plastic resin or polyurethane foam, to form the core of those balls. There are drawbacks to these prior art attempts, especially in the performance values of important properties for these balls. Other issues with at least one of these prior attempts can include longer cycle times, or production times, non-uniformity of these foam cores, and the need for additional processing steps, such as grinding, to further prepare the cores for acceptance of the cover of the ball.

The current art that uses polyurethane materials requires a large tolerance range for the physical characteristics of the ball. These large ranges can lead to large performance ranges of the finished product and greatly vary the performance criteria between balls. Further, current polyurethane materials used exhibit changes in performance criteria due to the effects of temperature and humidity on the mechanical properties of the ball. The performance properties of concern include compressibility, coefficient of restitution, dynamic stiffness, and durability. For example, the specific tolerance values under current polyurethane material that fall within the manufacturer accepted levels include:
Compression=+/−50 lbs.
COR=+/−0.025
Dynamic Stiffness=+/−500 lb/in.
Weight=+/−0.25 oz.

For the conventional balls made of polyurethane material, these ranges of variance can have large implications to the diamond sport game. This variance should be reduced, and preferably eliminated, for the normal environmental conditions in which a diamond sport occurs.

What is needed then is a new ball used in diamond sports wherein the ball has consistent performance properties with adequate durability, if not improved durability, over conventional balls. This needed ball is lacking in the art.

### BRIEF SUMMARY OF THE DISCLOSURE

The present disclosure relates generally to an injection molded ball core, and a method of manufacturing the ball core. Briefly, the present disclosure is directed, in an embodiment, to a ball core composition comprising a polycarbonate base resin, blowing agent with solubility in the base resin and a chain extension agent. In a further embodiment, the disclosure is directed to a method of manufacturing the same. In a preferred embodiment, the chain extension agent comprises pyromellitic dianhydride. In certain embodiments, the chain extension source consists solely of pyromellitic dianhydride. In embodiments of the ball core composition of the disclosure, the chain extension agent is present at a level of up to about 1% by weight. In other embodiments, the chain extension agent is present in the ball core composition at a level of up to about 0.5% by weight. In still other embodiments, the chain extension agent is present in the ball core composition at a level of up to about 0.1% by weight.

The disclosure is also directed to a ball core composition comprising:
a. about 98.9% by weight of a polycarbonate base resin;
b. about 0.1% by weight of a blowing agent; and
c. about 1% by weight of a chain extension agent.

In some embodiments, the ball core composition includes about weight 2.5-6.5% by weight of an impact modifier, more preferably about 3.9-5.3% by weight of an impact modifier.

In yet another embodiment, the disclosure is directed to a core composition having improved performances, the composition comprising up to about 95% by weight of a polycarbonate base resin; 4.0-5.0% by weight of an impact modifier, a blowing agent up to about 0.1% by weight and, optionally, a chain extension agent.

An important embodiment of the present invention provides a commercially expedient method for manufacturing improved injection molded foam cores having excellent properties, such as, for example, weight, density, bound, coefficient of restitution, compression, and dynamic stiffness which, when used as cores for balls, provide balls which satisfy stringent industry specifications.

Still further, an embodiment of the present invention is a ball core which enables a ball to maintain its playing properties and perform consistently at different locations regardless of temperature or humidity. Examples of extremes include 40-110 degrees F. temperature, and 20% - 80% humidity. See FIG. 3.

Objects, features and advantages of the present disclosure will be readily apparent to those skilled in the art upon reading of the following disclosure when taken in conjunction with the accompanying drawings.

### BRIEF DESCRIPTION OF THE SEVERAL VIEWS OF THE DRAWINGS

FIG. 1 is a side view of one embodiment of the present invention.

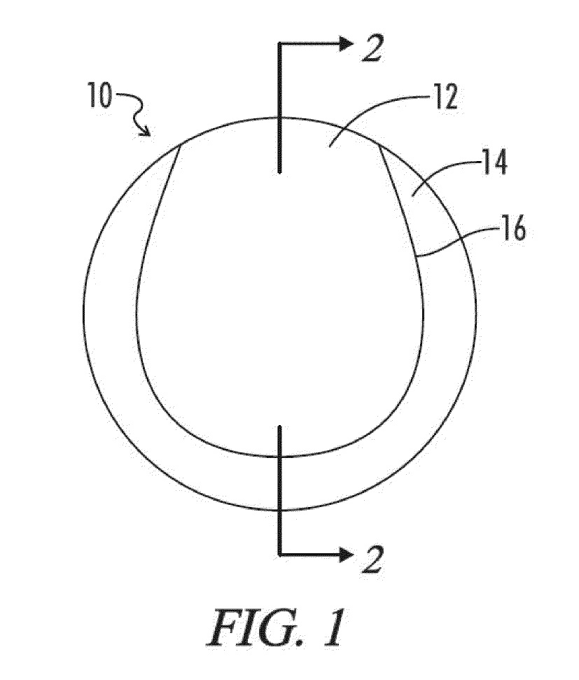

FIG. 2 is a cross-sectional view of one embodiment of the present invention.

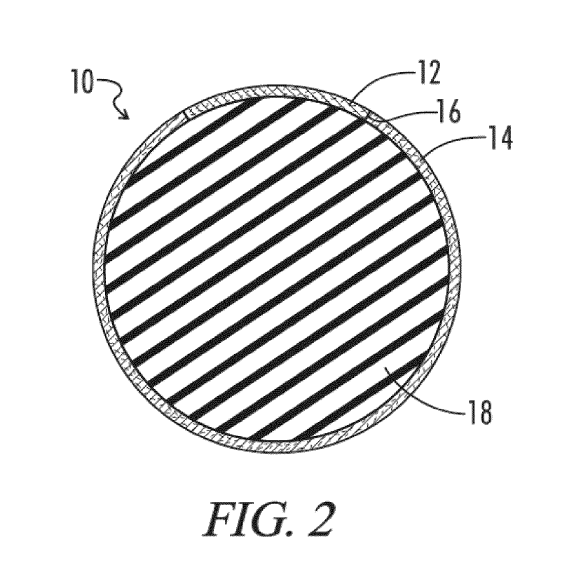

FIG. 3 is a graph of the compression performance for instant composition (hot dot) as compared to the compression performance of standard polyurethane.

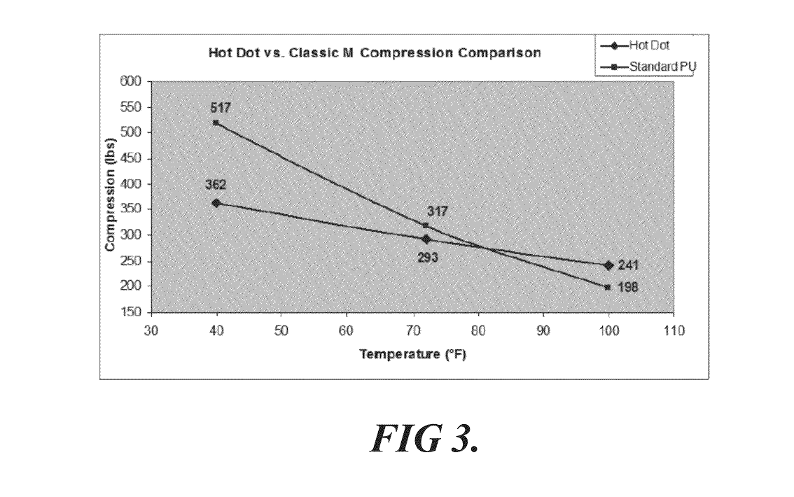

### DETAILED DESCRIPTION OF THE DISCLOSURE

The technical problem to be solved by the present invention is to provide a novel injection molded foam core compositions with improved performance tolerances by a method of manufacturing which reduces processing times and provides the option of overmolding the polymer skin to avoid the customary stitching step. In an embodiment, the invention is directed to a ball core composition comprising a polycarbonate base resin, blowing agent with solubility in the base resin and a chain extension agent. In a preferred embodiment the composition comprises up to about 95% by weight of a polycarbonate base resin; 4.0-5.0% by weight of an impact modifier, up to about 0.1% by weight of a blowing agent and, optionally, a chain extension agent. The core is preferably made of an injection molded foam that provides improved ball performance tolerances and durability as compared to prior art molded balls.

Suitable polycarbonate base resins for practicing the present disclosure may be any known or used in the art, including but not limited to, polyethylene terephthalate, polybutalene terephthalate, polytrimethylene terephthalate, polylactic acid, acrylonitrile butadiene styrene, polycarbonate, polystyrene, high impact polystyrene, and any combinations thereof. All materials have a glass transition temperatures higher than the use temperature (less than 45 C) which leads to improve durability, and eliminates aging effect. All materials have a glass transition temperatures higher than the use temperature (less than 45 C) which leads to improve durability, and eliminates aging effect.

In certain embodiments the blowing agent source comprises chemical blowing agents which release CO₂ or N₂ gas upon heating. Chemical blowing agents useful in practicing the present disclosure include, but are not limited to, hydrazodicarboxylates, benzamides, and amide derivatives of azodicarboxylic acid, as well as agents which are based on sodium bicarbonate or aluminum hydroxide. Chemical blowing agents may be substituted with physical blowing agents. Suitable physical blowing agents include, but are not limited to, pentane, CO₂ gas, N₂ gas, or combinations thereof. Blowing agents may either be single component or mixed agents.

Suitable chain extension agents include, but are not limited to pyromellitic dianhydride, methylenediphenyl diisocyanate, and combinations thereof.

In certain embodiments of the disclosure, the injection molded foam core composition may contain an impact modifier. The term “impact modifier” is defined as a supplement incorporated in polymer compositions to improve the impact resistance of finished articles. Any impact modifier known in the art may be acceptable for use in the present disclosure provided it achieves the intended result. In a particular embodiment, the impact modifier may be selected from styrenic block copolymers; polybutylene terephthalate (suitable in polycarbonate), polyetheramines, styrenic graft polymers, and acrylonitrile butadiene styrene copolymer (ABS).

In further embodiments, the injection molded foam core compositions may include a tackifying agent. A “tackifying agent” is defined as an additive to a polymer formulation to allow adhesion of an injection molded foam core to a leather, or synthetic shell without a gluing step. This further reduces, and/or eliminates, the amount of labor required to manufacture a ball, which therefore reduces the production cost. Any tackifying agent known in the art may be acceptable for use in the present disclosure provided it achieves the intended result. In a particular embodiment, the tackifying agent is poly(styrene-co-maleic anhydride). In a preferred embodiment, the tackifying agent is poly(styrene-co-maleic anhydride) present at 0.25-2% by weight.

The injection molded foam core of the disclosure, in some embodiments, may further include a nucleating agent. A nucleating agent , can be used to control the cell size density. The cell size density can directly affect the mechanical properties and performance of the ball. Preferably, the nucleating agent is talc. Any nucleating agent known in the art may be acceptable for use in the present disclosure provided it achieves the intended result. Other suitable nucleating agents include, but are not limited to, howlite, titanite, guyana bauxite (gibbsite), arkansas bauxite (gibbsite), spanish sepiolite, lepidolite, stilbute, petalite, calcium aluminate, and azurite.

In at least one embodiment, ABS is about 40-99.8% by weight; the high impact polystyrene is about 0-60% by weight; the sodium bicarbonate is about 0.1 to 1% by weight; and the talc is about 0.05-1% by weight.

In a preferred embodiment, the composition is comprised of about 95% by weight of AB; about 4.5-5.2% by weight of the high impact polystyrene is, the sodium bicarbonate is about 0.1% by weight and talc is about 0.05% by weight. The mixture further comprises a chain extension agent. Suitable chain extension agents include 0.01-1% by weight of pyromellitic dianhydride or 0.01-0.5% by weight of methylenediphenyl diisocyanate.

In a further embodiment, polyethylene terephthalate and polybutylene terephthalate are mixed with chain extenders or coupling agents comprising of Joncryl ADR4385 or Joncryl ADR4368C at 0.1-1.5%, pyromellitic dianhydride chain extender at 0.01-1% or methylenediphenyl diisocyanate at 0.01-0.5%, sodium bicarbonate blowing agent at 0.1-2% and an optional nucleating agent.

An important embodiment of the present invention includes the method for manufacturing the improved injection molded foam cores. The method of this invention comprises (1) forming a reaction mixture including a polycarbonate base resin, a blowing agent, and a chain extension agent inside an injection molding machine, (2) injecting reaction mixture into at least one spherical mold cavity, (3) maintaining the reaction mixture inside the mold at reaction conditions including a temperature of from about 150° F.-170° F. for a time sufficient to form an injection molded foam core inside the mold, (4) removing the foam core from the mold, and (5) curing the formed foam core.

In actual practice, the blowing agent is homogeneously mixed with the particular polycarbonate base resin in particulate form, by tumble blending at ambient temperature. The particulate mixture is mixed under temperature and pressure conditions suitable to homogenize the mixture and form a dispersion or solution of the blowing agent in the resin. The dispersion or solution is extruded and cut into pellets or ground into powder form. The extruded material is often called a masterbatch. The blowing agent is incorporated into the resin used in the final ball by tumble blending the particulate polycarbonate material with the masterbatch. Typically a masterbatch yielding 30 to 50 mls/gram and preferably 35 to 45 mls of gas at standard temperature and pressure is desired. Consequently the masterbatch is used at a range of 1-6% by weight based on the weight of the total. resin and preferably 1%-5% and more preferably 1% -2% for baseballs and 4% to 6% and more preferably 4.5%-5.5% for softballs.

The process of the invention is practiced in a conventional injection molding machine. The polycarbonate resin. in particulate form is tumble blended with the masterbatch until homogeneous. The blend is charged to the hopper of an injection molding machine which melts the resin under heat and pressure converting it to a flowable polycarbonate mass. The nozzle of the injection nozzle molding machine is in liquid flow communication with a mold whose mold cavity or cavities is of substantially the same dimension as the final core. The molds are water cooled to a temperature of 32° to 65° F. and preferably 35° to 45° F. which is necessary to form a skin on the surface of the polycarbonate resin mass injection into the mold. Upon injection of the required amount of polycarbonate resin material into the mold cavity, the mold is continuously cooled with water to maintain the mold cavity surface at the low temperature.

The use of these compositions for the foam core can decrease the range, variance and tolerance values for several performance properties within the balls. For example, the ball having a core made using these new compositions can include performance tolerance values as follows:
Compression=+/−25 lbs
COR=+/−0.0125
Dynamic Stiffness=+/−250 lb/in.
Weight=+/−0.125 oz

Further, the compositions and methods of the present disclosure can controllably vary the density and weight of the ball. This variance in weight could be accomplished with the injection molding process and could even use the same mold. These compositions allow for a greater control and consistency of the finished core density and weight when used in an injection molded process.

The improved tighter performance tolerances for the balls that are possible with the disclosed injection molded foam cores will allow the balls to be manufactured closer to the specification limits. This allows for a maximum performance of the ball without exceeding those limits. Further, the injection molded foam cores have performance characteristics that allow a consistent performance of the ball in varying temperature and humidity environments. This consistent, if not unchanged, performance level with a ball made with the new composition is not present in current polyurethane cores.

Consistency of performance in the balls can improve due to an increased cell uniformity of the composition being used to create the core. This increased cell uniformity is improved over the current polyurethane cores in the art or the variability observed in EVA foam by authors of U.S. Pat. Nos. 4,144,297 and 4,211,407.

Further, the instant composition with use of injection molding method can allow the reduction of cycled time from a typical thirty day production cycle to a matter of minutes, such as five minutes or less. This further allows for a more extensive automation of the ball production process and allows a much less physically intensive production process and allows for a greater production consistency.

### EXAMPLES

The following examples are provided to illustrate some embodiments of the injection molded foam core composition of the present disclosure but should not be interpreted as any limitation thereon. Other embodiments within the scope of the claims herein will be apparent to one skilled in the art from the consideration of the specification or practice of the core composition or methods disclosed herein. It is intended that the specification, together with the example, be considered to be exemplary only, with the scope and spirit of the disclosure being indicated by the claims which follow the example.

### Example 1

A 170 ton Van Dorn is equipped with 3 gravimetric feeders. Feeder 1 is fed 85 weight percent Bayer Makrolon® 3208 polycarbonate powder which was dried in a hopper dryer at 120° C. for 6 hours. Resin hopper is blanketed with nitrogen gas providing cooling with negligible moisture uptake. Feeder 2 is fed 2.1 weight percent in total, equal parts of sodium bicarbonate, Cimbar Flextalc talc powder and BASF Joncryl ADR-4370 in a salt-pepper blend. Feeder 3 is fed 12.9 weight percent Americas Styrenics Styron 487, a high impact polystyrene. Extruder is equipped with mixing screw and tip. Max extruder temperature is 465° F. Polymer melt temperature at extruder tip is 435° F. Mold temperature is 160° F. and cooling is facilitated by water. Fill time is 1 second. Hold time is 0.5 seconds. Mold closed time is 300 seconds. Final shot weight is 138-142 grams.

MDI (methylenediphenyl diisocyanate) or titanates may also be used as the chain extension opposite the Joncryl ADR-4370. Other chemical blowing agents like ethylene carbonate may be substituted or mixed with sodium carbonate.

Supercritical carbon dioxide can be substituted for chemical blowing agents, but require capital investment.

High impact polystyrene can be replaced by other styrene block copolymers.

### Example 2

A 170 ton Van Dorn is equipped with 2 gravimetric feeders. Each feeder meters known amount of resin or additives. Feeder 1 is fed 98 weight percent Sabic's Cycolac GPX 3700 ABS or GX3800F. It's dried at 80° C. for 6 hours. Feeder 2 is fed 2.1 by weight percent in total, equal parts of sodium bicarbonate, Cimbar Flextalc talc powder and BASF Joncryl ADR-4370 in a salt-pepper blend. Extruder is equipped with mixing screw and tip. Max extruder temperature is 390° F. Polymer melt temperature at extruder tip is 355° F. Mold temperature is 160° F. and cooling is facilitated by water. Fill time is 1 second. Hold time is 0.5 seconds. Mold closed time is 240 seconds. Final shot weight is 138-142 grams.

Diisopropoxy-bis-acetoacetotitinate, TCA-DC from Capaute Chemicals at 0.1% can replace the Joncryl ADR-4370. However, TCA-DC is challenging to meter as it is used at low concentrations.

In at least one embodiment, performance metrics and tolerances for the ball core composition as described are as follows:

| | | | | | New |
|---|---|---|---|---|---|
| | Performance | | | | Composition |
| Specification | Metrics | | | | Achievable |
| Category | Core only | | Current Tolerance | | Tolerance |
| Circumference | 11.55 | in. | +/−0.1 | in. | +/−0.05 |
| Weight | 5.30 | oz | +/−0.1 | oz | +/−0.05 |
| Density | 21.5 | lbs/cu.ft. | +/−1.5 | lbs/cu.ft. | +/−0.5 |
| Static | 300 | lbs max. | +/−50 | lbs | +/−25 lbs |
| Compression | | | (200-300) | | To |
| | | | | | +/−5 lbs |
| COR | 0.52 | max. | +/−0.01 | | +/−0.005 |
| (Coefficient | | | (0.50-0.52) | | |
| of | | | | | |
| Restitution) | | | | | |
| Dynamic | 5500 | lbs/in max. | +/−250 | lbs./in. | +/−100 |

| | | |
|---|---|---|
| Stiffness | (5000-5500) | +/−50 |

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties. The discussion of the references herein is intended merely to summarize the assertions made by their authors and no admission is made that any reference constitutes prior art. Applicants reserve the right to challenge the accuracy and pertinence of the cited references.

Although preferred embodiments of the disclosure have been described using specific terms, devices, and methods, such description is for illustrative purposes only. The words used are words of description rather than of limitation. It is to be understood that changes and variations may be made by those of ordinary skill in the art without departing from the spirit or the scope of the present disclosure, which is set forth in the following claims. In addition, it should be understood that aspects of the various embodiments may be interchanged both in whole or in part. For example, while methods for the production of an injection molded foam core are made according to those methods have been exemplified, other uses are contemplated. Therefore, the spirit and scope of the appended claims should not be limited to the description of the preferred versions contained therein.

Thus, although there have been described particular embodiments of the present invention of a new and useful “BALL WITH INJECTION MOLDED FOAM CORE,” it is not intended that such references be construed as limitations upon the scope of this invention.

What is claimed is:

1. An injection molded foam core composition for a ball, comprising:
a. a polycarbonate base resin;
b. a blowing agent with solubility in the base resin; and
c. a chain extension agent.

2. The composition of claim 1, wherein the base resin is selected from a group consisting of polyethylene terephthalate, polybutalene terephthalate, polytrimethylene terephthalate, polylactic acid, acrylonitrile butadiene styrene, polycarbonate, polystyrene, high impact polystyrene, and any combinations thereof.

3. The composition of claim 1, wherein the polycarbonate base resin comprises acrylonitrile butadiene styrene (ABS).

4. The composition of claim 1, wherein the ABS is about 40-99.8% by weight of the total composition.

5. The composition of claim 1, wherein the blowing agent comprises sodium bicarbonate.

6. The composition of claim 1, wherein the sodium bicarbonate is about 0.1 to 1% by weight.

7. The composition of claim 1, wherein the chain extension agent is selected from a group consisting of pyromellitic dianhydride and methylenediphenyl diisocyanate.

8. The composition of claim 1, wherein the pyromellitic dianhydride is about 0.01-1% by weight.

9. The composition of claim 1, wherein the methylenediphenyl diisocyanate is about 0.01-0.5% by weight.

10. The composition of claim 1, further comprising an impact modifier.

11. The composition of claim 1, wherein the impact modifier is 0-59% by weight of high impact polystyrene.

12. The composition of claim 1, further comprising a nucleating agent.

13. The composition of claim 1, wherein the nucleating agent is about 0.05-1% by weight of talc.

14. The composition of claim 1, further comprising an tackifying agent.

15. The composition of claim 1, wherein the tackifying agent is about 0.25-2% by weight of poly(styrene-co-maleic anhydride).

16. The composition of claim 1, wherein the ABS is about 40-99.8% by weight;
the high impact polystyrene is about 0-59% by weight; the sodium bicarbonate is about 0.1 to 1% by weight; and the talc is about 0.05-1% by weight.

17. The composition of claim 1, wherein the ABS is about 95% by weight; the high impact polystyrene is about 4.85% by weight, the sodium bicarbonate is about 0.1% by weight and talc is about 0.05% by weight.

18. A method of forming a ball core for diamond sports comprising:
a. feeding a polycarbonate base resin, a blowing agent, a chain extension agent, and a tackifying agent into an injection molding machine equipped with gas counterflow;
b. heating to polymer melt temperature;
c. forming a flowable homogenous mass including the polycarbonate base resin, the blowing agent, the chain extension agent, and the tackifying agent
d. injecting said mixture into at least one mold cavity; and
e. maintaining the reaction mixture inside the mold cavity at reaction conditions sufficient to form a tackified foam core
f. removing the foam core from the mold;
g. curing the foam core.

19. The method of claim 14, wherein said polycarbonate base resin is selected from a group consisting of thermoplastic polyurethanes, acrylonitrile butadiene styrene, polyethylene terephthalate, polybutalene terephthalate, polytrimethylene terephthalate, polylactic acid, co-polyester, polycarbonate, polystyrene, high impact polystyrene, polyolefin, and polyolefin with cross-linking agents, ethyl vinyl acetate, polyvinyl acetate, polyvinyl alcohol, and polyvinyl nitrile.

20. The method of claim 14, wherein said polycarbonate base resin is acrylonitrile butadiene styrene.

21. The method of claim 14, wherein the blowing agent is sodium bicarbonate.

22. The method of claim 14, wherein the chain extension agent is pyromellitic dianhydride chain extender at 0.01-1% by weight or methylenediphenyl diisocyanate at 0.01-0.5% by weight.

23. The method of claim 14, wherein the adhesion additive is poly(styrene-co-maleic anhydride) at 0.25-2% by weight.

24. The method of claim 14, wherein said mass is held in said mold for 240 seconds to 310 seconds.

25. The method of claim 14, wherein said mold is cooled to a temperature of 150° F.-170° F.

26. The method of claim 14, wherein said curing is provided by immersing mold in a cooling bath of 150° F.-170° F.
